(19) United States
(12) Patent Application Publication
(10) Pub. No.: US 2016/0309641 A1
(43) Pub. Date: Oct. 27, 2016

(54) PARALLEL LINKAGE FOR CONNECTING TOOL BARS

(71) Applicants: Mike Taunton, Sparks, GA (US); Charles Sumner, Chula, GA (US); Keegan Hanie, Tifton, GA (US)

(72) Inventors: Mike Taunton, Sparks, GA (US); Charles Sumner, Chula, GA (US); Keegan Hanie, Tifton, GA (US)

(73) Assignee: Kelley Manufacturing Company, Inc., Tifton, GA (US)

(21) Appl. No.: 14/205,796

(22) Filed: Mar. 12, 2014

(51) Int. Cl. A01B 63/02; A01B 49/02; A01B 61/04

(52) U.S. Cl. CPC A01B 63/02; A01B 61/046; A01B 49/027

(57) ABSTRACT

An apparatus for maintaining a secondary tool bar in spaced relation to a primary toolbar utilizes a spring biased quadrilateral linkage connected between the primary and secondary tool bars independently of any tools mounted on said bars such that said primary tool bar supports said secondary tool bar and any tools mounted thereon.

### FIELD OF INVENTION

The present invention relates to agricultural implements used behind tractors to work the soil and more particularly the use of multiple tool bars to carry multiple implements behind tractors. Even more particularly the present invention relates to linkages between primary and secondary tool bars.

### SUMMARY OF THE INVENTION

It is an object of the current invention to save vital mounting space on the main tool bar of an agricultural tillage machine. Yet another object is to provide improved economy over individual linkages for each row of secondary tillage tools as seen on some competitor's machines. A still further object is to facilitate the connection of multiple implements in a labor saving manner. Each of these is accomplished in the present design which further avoids the creation of un-worked soil when the secondary tillage tools are directly mounted to the primary tillage tool, as seen on Pat. No. 4,068,061, when the tool is tripped.

### BRIEF DESCRIPTION OF THE DRAWINGS

Referring to the drawings which are appended hereto and which form a portion of this disclosure, it may be seen that:

FIG. 1 is a side elevational view of an embodiment of the present invention;

FIG. 2 is a perspective view of tillage equipment using an embodiment of the present invention to connect two tool bars with implements attached thereto:

### DETAILED DESCRIPTION

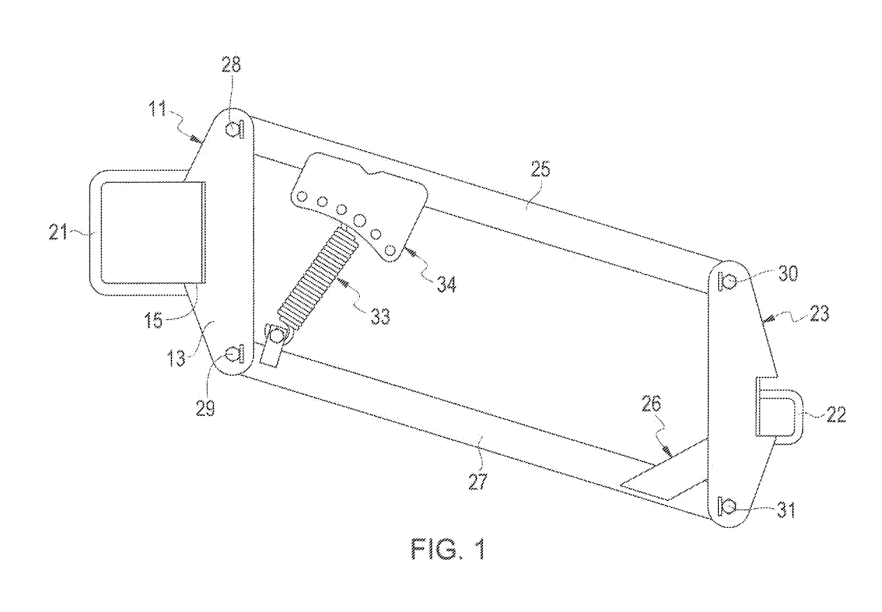

One or more of the above objects can be achieved, at least in part, by providing parallel linkage on a tillage machine to connect the main toolbar to a secondary toolbar(s) on which secondary tillage tools are mounted. FIG. 1 shows the parallel linkage mechanism 10. Referring to FIG. 1, a main tool bar bracket 11 is the connection component to the main toolbar 17. Bracket 11 includes a pair of spaced apart plates 13 having a notch 15 formed therein for engagement with a main toolbar 17. A spacer plate 19 connects the spaced apart plates 15 and may be secured thereto by welding or by forming the plates 13 and spacer plate 19 from a single steel plate. A U-bolt 21 and associated nuts are conventionally used to secure the bracket 11 to main tool bar 17.

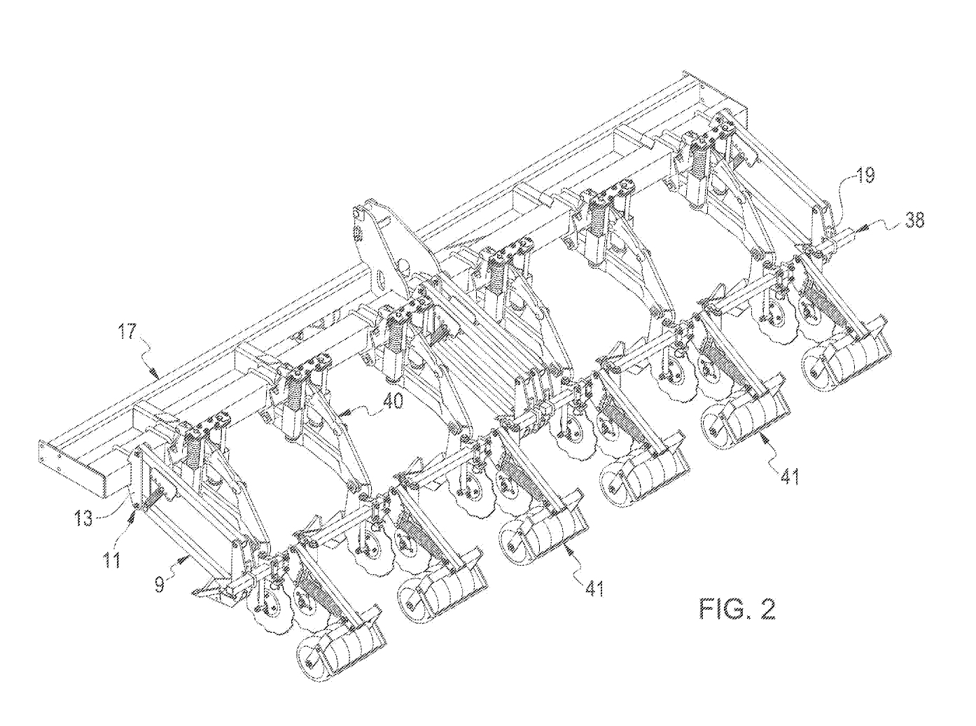

A rear bracket 23 is the connection piece to the secondary toolbar. The structure of rear bracket 23 mirror that of main tool bar bracket 11 including the plates 13, notches 15, and spacer plate 19. U-Bolt 22 is used to connect the secondary bracket to the secondary tool bar 38 in FIG. 2. Link members 25 and 27 are pivotally connected to the brackets 11 and 23 by pivot pins 28 to 31. A stop 26 affixed to link member 27 engages bracket 23 to inhibit the quadrilateral linkage from collapsing beyond a set angular measure. Spring 33 applies adjustable spring down pressure on the parallel links depending on its connection point to spring bracket 34 and thus insures that the secondary strip tillage as shown in FIG. 2 properly engages the ground. If spring down pressure is unneeded, the spring 33 can be easily removed.

FIG. 2 shows the parallel linkage 10 connecting the main toolbar to the secondary toolbars 38. Primary tillage tools 40 are mounted in two sets of three tools to the main tool bar 17 which is conventionally a strong weldment connected to the tractor or prime mover that pulls the tillage apparatus across a field. Near the center of the main tool bar 17 a pair of parallel linkage 10 are connected to the main tool bar 17 and to adjacent ends of two secondary toolbars 38. Likewise near the ends of main tool bar 17 a second pair of parallel linkage 10 are connected to the outer ends of secondary tool bars 38 thus forming a secure connection to which secondary tools can be mounted. Tying multiple rows of strip tillage tools together on a secondary toolbars 38 saves vital mounting space on the main toolbar 17. In turn, linking to secondary toolbars is more economical individual linkages for each row of secondary tillage tools. As may be seen in FIG. 2, the secondary toolbars 38 span multiple rows. Parallel linkages 10 allow for constant engagement of secondary tillage tools 41 with the ground irrespective of the displacement of the primary tillage tools 40.

The use of a secondary toolbars on such units ensures consumer flexibility. The consumer can easily change secondary tillage tools by replacing the secondary toolbars 38 or changing the secondary tillage tools 41 individually. The farmer has enormous flexibility to switch between secondary strip tillage equipment, or to change to secondary bedding tillage equipment simply by connecting the secondary tool bar 38 with the desired tools mounted thereon. Thus, allowing the farmer to convert his Rip-Strip machine to a Ripper-Bedder machine with considerably less work than previous machines.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What I claim is:

1. An apparatus for maintaining a secondary tool bar in spaced relation to a primary toolbar comprising:
a. A first bracket for engaging a primary toolbar;
b. A second bracket for engaging a secondary toolbar; and,
c. Linkage members pivotally mounted to said first and second brackets to form a quadrilateral.

2. An apparatus as defined in claim 1 further comprising a spring adjustably connected between said linkage members for providing a downward biasing force to said quadrilateral.

3. Apparatus as defined in claim 1 further comprising
a. A third bracket for engaging said primary toolbar;
b. A fourth bracket for engaging said secondary toolbar;
d. Secondary Linkage members pivotally mounted to said third and fourth tool bar brackets to form a quadrilateral; and,
d. A secondary tool bar supported by said brackets with said brackets spaced apart on said secondary tool bar to allow secondary tillage tools to be attached to said secondary tool bar.

4. In a tillage device having main tool bar and a plurality of primary tillage tools supported on said main tool bar, the improvement comprising;
a. A secondary tool bar having two or more secondary tillage tools mounted thereon;
b. At least two forward brackets for engaging said main toolbar in spaced relation along said main toolbar;
c. A least two secondary brackets for engaging said secondary toolbar in like spaced relation along said secondary toolbar; and,
d. Linkage members pivotally mounted between said forward and secondary brackets to form a spaced apart quadrilateral frame capable of maintaining said secondary toolbar and any tools mounted thereon in spaced relation to said main toolbar.
